(19) United States
(12) Patent Application Publication
(10) Pub. No.: US 2024/0347787 A1
(43) Pub. Date: Oct. 17, 2024

(54) Methods and Systems for Restoring Lithium Metal Liquid-Electrolyte Electrochemical Cells

(71) Applicant: Cuberg, Inc., San Leandro, CA (US)

(72) Inventors: Asang Mehta, San Francisco, CA (US); Jack Fawdon, San Leandro, CA (US); Kathryn Hicks, San Leandro, CA (US); Trung Ha, San Leandro, CA (US); Jeremy Gong, San Leandro, CA (US); Seamus Bannon, Oakland, CA (US); Yun Sik Oh, San Leandro, CA (US)

(73) Assignee: Cuberg, Inc., San Leandro, CA (US)

(21) Appl. No.: 18/633,975

(22) Filed: Apr. 12, 2024

Related U.S. Application Data
(60) Provisional application No. 63/496,074, filed on Apr. 14, 2023.

(51) Int. Cl. H01M 10/42; H01M 10/44

(52) U.S. Cl. CPC H01M 10/4242; H01M 10/44

(57) ABSTRACT

Described herein are methods and systems for restoring LiMLE cells by cycling such cells using restoring conditions comprising specially selected restoring discharge current (e.g., at least 1 D) and a restoring charge current (e.g., less than 0.5 C). This restoration cycling can be triggered when a LiMLE cell reaches a restoring threshold, determined based on one or more of the following operating and resting conditions: a discharge capacity, an overpotential, an impedance, a direct-current (DC) resistance, the rest period duration, an open circuit voltage, operating discharge and/or charge currents, and an operating cycle count. The restoring threshold is selected to reflect the negative electrode state in a LiMLE cell. The restoring conditions are selected to change this negative electrode state to improve the performance of the LiMLE cell. For example, the restoring discharge can reduce the cell's state of charge (SOC) by at least 10%.

### CROSS-REFERENCE TO RELATED APPLICATIONS

This application claims the benefit under 35 U.S.C. § 119 (e) of U.S. Provisional Patent Application 63/496,074, filed on 2023 Apr. 14, which is incorporated herein by reference in its entirety for all purposes.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries generated many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, LiM cells utilize the direct deposition (e.g., plating) of lithium metal on the negative current collectors without a need for any additional active materials for trapping lithium ions. As such, LiM cells tend to have a lower weight and a higher energy density in comparison to Li-ion cells. For example, LiM has a specific capacity of 3,860 mAh/g, which is about ten times higher than that of graphite. However, LiM cells or, more generally, LiM batteries are currently not widely adopted at the scale of Li-ion batteries for various reasons presented below.

LiM liquid-electrolyte (LiMLE) cells represent a specific category of LiM cells in which liquid electrolytes are used to transport lithium ions between positive and negative electrodes. It should be noted that the majority of LiM batteries currently use solid electrolytes, which provide a simpler control over lithium metal deposition but have various other drawbacks. The charge rates of LiMLE cells are typically limited due to the specific nature of lithium incorporation on negative electrodes, i.e., direct plating on the electrode surface (rather than being incorporated into a host material by intercalation or alloying as it occurs in Li-ion cells). Lithium surface plating can be very sensitive to charge rates. For example, high charge rates can cause uneven lithium-metal deposition (e.g., because of the uneven distribution of lithium ions within the electrolyte, in particular, highly-viscous electrolytes used in LiMLE cells). Furthermore, metallic lithium is highly reactive with various compounds (e.g., liquid electrolyte components), especially driven by the high electrochemical potential associated with fast charging. As a result, LiMLE cells can experience early capacity fading, which significantly shortens the cycle life of such cells.

What is needed are new methods and systems for restoring LiMLE cells.

### SUMMARY

Described herein are methods and systems for restoring LiMLE cells by cycling such cells using restoring conditions comprising specially selected restoring discharge current (e.g., at least 1 D) and a restoring charge current (e.g., less than 0.5 C). This restoration cycling can be triggered when a LiMLE cell reaches a restoring threshold, determined based on one or more of the following operating and resting conditions: a discharge capacity, an overpotential, an impedance, a direct-current (DC) resistance, the rest period duration, an open circuit voltage, operating discharge and/or charge currents, and an operating cycle count. The restoring threshold is selected to reflect the negative electrode state in a LiMLE cell. The restoring conditions are selected to change this negative electrode state to improve the performance of the LiMLE cell. For example, the restoring discharge can reduce the cell's state of charge (SOC) by at least 10%.

Clause 1. A method for restoring a lithium-metal liquid-electrolyte electrochemical cell comprising a lithium-metal negative electrode and a liquid electrolyte comprising a lithium-containing salt and a liquid solvent, the method comprising: cycling the lithium-metal liquid-electrolyte electrochemical cell using operating conditions comprising an operating discharge current and an operating charge current; determining a restoring threshold of the lithium-metal liquid-electrolyte electrochemical cell; and when the lithium-metal liquid-electrolyte electrochemical cell reaches the restoring threshold, cycling the lithium-metal liquid-electrolyte electrochemical cell using restoring conditions comprising a restoring discharge current and a restoring charge current thereby restoring the lithium-metal liquid-electrolyte electrochemical cell, wherein the restoring discharge current is at least 1 D on average.

Clause 2. The method of clause 1, wherein the restoring threshold is determined based on one or more of: a discharge capacity of the lithium-metal liquid-electrolyte electrochemical cell while cycling using the operating conditions, an overpotential of the lithium-metal liquid-electrolyte electrochemical cell while cycling using the operating conditions, an impedance of the lithium-metal liquid-electrolyte electrochemical cell, a direct-current (DC) resistance of the lithium-metal liquid-electrolyte electrochemical cell, duration of a rest period since cycling the operating conditions, an open circuit voltage (OCV) during the rest period since cycling using the operating conditions, the operating discharge current and the operating charge current during cycling using the operating conditions, and an operating cycle count using the operating conditions after a prior restoration of the lithium-metal liquid-electrolyte electrochemical cell.

Clause 3. The method of clause 2, wherein: the restoring threshold is determined based on the discharge capacity of the lithium-metal liquid-electrolyte electrochemical cell while cycling using the operating conditions, and the lithium-metal liquid-electrolyte electrochemical cell reaches the restoring threshold when the discharge capacity is 5-30% relative to an initial capacity.

Clause 4. The method of clause 2, wherein: the restoring threshold is determined based on the overpotential of the lithium-metal liquid-electrolyte electrochemical cell while cycling using the operating conditions, and the lithium-metal liquid-electrolyte electrochemical cell reaches the restoring threshold when the overpotential increases by 0.1-1.0V over an initial overpotential.

Clause 5. The method of clause 2, wherein: the restoring threshold is determined based on the impedance of the lithium-metal liquid-electrolyte electrochemical cell, and the lithium-metal liquid-electrolyte electrochemical cell reaches the restoring threshold when the impedance increases by 10-50% relative to an initial impedance.

Clause 6. The method of clause 2, wherein: the restoring threshold is determined based on the direct-current (DC) resistance of the lithium-metal liquid-electrolyte electrochemical cell, and the lithium-metal liquid-electrolyte electrochemical cell reaches the restoring threshold when the direct-current (DC) resistance increases by 10-50% relative to an initial direct-current (DC) resistance.

Clause 7. The method of clause 2, wherein: the restoring threshold is determined based on the duration of the rest period since cycling the operating conditions, and the lithium-metal liquid-electrolyte electrochemical cell reaches the restoring threshold when the duration of the rest period is 8 weeks to 1 year.

Clause 8. The method of clause 2, wherein: the restoring threshold is determined based on the open circuit voltage (OCV) during the rest period since cycling using the operating conditions, and the lithium-metal liquid-electrolyte electrochemical cell reaches the restoring threshold when the open circuit voltage (OCV) drops by at least about 0.05V.

Clause 9. The method of clause 1, wherein cycling the lithium-metal liquid-electrolyte electrochemical cell using the restoring conditions comprises discharging the lithium-metal liquid-electrolyte electrochemical cell using the restoring discharge current by 5-50% of a discharge capacity of the lithium-metal liquid-electrolyte electrochemical cell.

Clause 10. The method of clause 1, wherein the restoring conditions further comprise a restoring discharge cutoff voltage of less than 3.7V such that the lithium-metal liquid-electrolyte electrochemical cell is discharged using the restoring discharge current until the restoring discharge cutoff voltage.

Clause 11. The method of clause 1, wherein the restoring discharge current is at least 0.75 D.

Clause 12. The method of clause 1, wherein the restoring discharge current is at least 2 times greater than the restoring charge current.

Clause 13. The method of clause 1, wherein the lithium-metal liquid-electrolyte electrochemical cell is part of a battery pack such that the battery pack is cycled in accordance with the restoring conditions.

Clause 14. The method of clause 13, wherein the restoring threshold is determined based on one or more characteristics of additional lithium-metal liquid-electrolyte electrochemical cells in the battery pack.

Clause 15. A battery system for restoring a lithium-metal liquid-electrolyte electrochemical cell, the battery system comprising: a power supply configured to flow an electric current through the lithium-metal liquid-electrolyte electrochemical cell in accordance with a set of restoring conditions comprising a restoring charge current and a restoring discharge current; and a controller, communicatively coupled to the power supply and comprising: a memory storing the restoring conditions and operating parameters of the lithium-metal liquid-electrolyte electrochemical cell, and a processor configured to determine a restoring threshold of the lithium-metal liquid-electrolyte electrochemical cell such that when the lithium-metal liquid-electrolyte electrochemical cell reaches the restoring threshold, the processor is configured to instruct the power supply to cycle the lithium-metal liquid-electrolyte electrochemical cell using restoring conditions comprising a restoring discharge current and a restoring charge current thereby restoring the lithium-metal liquid-electrolyte electrochemical cell, wherein the restoring discharge current is at least 1 D on average.

Clause 16. The battery system of clause 15, wherein the restoring threshold is determined based on one or more of: a discharge capacity of the lithium-metal liquid-electrolyte electrochemical cell while cycling using the operating conditions, an overpotential of the lithium-metal liquid-electrolyte electrochemical cell while cycling using the operating conditions, an impedance of the lithium-metal liquid-electrolyte electrochemical cell, a direct-current (DC) resistance of the lithium-metal liquid-electrolyte electrochemical cell, duration of a rest period since cycling the operating conditions, an open circuit voltage (OCV) during the rest period since cycling using the operating conditions, the operating discharge current and the operating charge current during cycling using the operating conditions, and an operating cycle count using the operating conditions after a prior restoration of the lithium-metal liquid-electrolyte electrochemical cell.

Clause 17. The battery system of clause 16, wherein: the restoring threshold is determined based on the discharge capacity of the lithium-metal liquid-electrolyte electrochemical cell while cycling using the operating conditions, and the lithium-metal liquid-electrolyte electrochemical cell reaches the restoring threshold when the discharge capacity is 5-30% relative to an initial capacity.

Clause 18. The battery system of clause 16, wherein: the restoring threshold is determined based on the overpotential of the lithium-metal liquid-electrolyte electrochemical cell while cycling using the operating conditions, and the lithium-metal liquid-electrolyte electrochemical cell reaches the restoring threshold when the overpotential increases by 0.1-1.0V over an initial overpotential.

Clause 19. The battery system of clause 16, wherein: the restoring threshold is determined based on the impedance of the lithium-metal liquid-electrolyte electrochemical cell, and the lithium-metal liquid-electrolyte electrochemical cell reaches the restoring threshold when the impedance increases by 10-50% relative to an initial impedance.

Clause 20. The battery system of clause 16, wherein: the restoring threshold is determined based on the direct-current (DC) resistance of the lithium-metal liquid-electrolyte electrochemical cell, and the lithium-metal liquid-electrolyte electrochemical cell reaches the restoring threshold when the direct-current (DC) resistance increases by 10-50% relative to an initial direct-current (DC) resistance.

These and other embodiments are described further below with reference to the figures.

### BRIEF DESCRIPTION OF THE DRAWINGS

FIG. 1A is a block diagram of a LiMLE cell, illustrating various components of the cell, in accordance with some examples.

FIG. 1B is a block diagram of a battery pack comprising the LiMLE cell in FIG. 1A and a battery cycler, used for restoring the LiMLE cell, in accordance with some examples.

FIG. 2 is a process flowchart corresponding to a method for restoring a LiMLE cell, in accordance with some examples.

FIG. 3 is a plot of charge/discharge rates used for restoring a LiMLE cell, in accordance with some examples.

FIG. 4 is a schematic illustration of a state of charge (SOC) profile while restoring a LiMLE cell, in accordance with some examples.

FIG. 5A is a plot of relative capacities (as a function of the cycle count) for two LiMLE cells, one of which was subjected to restoration cycling.

FIG. 5B is a plot of a cycle life as a function of charge-discharge rates for different restoration cycling protocols.

FIG. 5C is a plot of overpotential profiles (as a function of the cycle count) for different operation cycling and/or restoration cycling protocols.

FIG. 5D is a plot of cell thicknesses (as a function of the cycle count) for different operation cycling and/or restoration cycling protocols.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### INTRODUCTION

Li-metal cells use lithium-metal negative electrodes (rather than intercalation materials such as graphite or alloying materials such as silicon) to store the metal lithium and the corresponding charge (electrical energy). In other words, lithium ions are plated metallically on the electrode surface in LiM cells (representing the condition that needs to be avoided in Li-ion cells). A specific type of Li-metal cells is lithium-metal liquid-electrolyte electrochemical (LiMLE) cells, in which the ionic exchange between LiM negative electrodes and positive electrodes is provided by liquid electrolytes (as opposed to solid and polymer electrolytes in other types of Li-metal cells).

The performance of LiMLE cells is dictated, at least in part, by the morphology of the LiM plating/deposit and other factors, such as solid electrolyte interface (SEI) formation. For example, LiMLE cells experience resistance increase over time due to the slow electrolyte decomposition when these batteries are left idle (not cycling) between intermittent usage periods. One test applied to LiMLE cells showed a 45% increase in direct current internal resistance (DCIR) when these cells were left idle (not charging or discharging) with approximately 10% state of charge (SOC) for several days.

Another factor greatly influencing the long-term performance of LiMLE cells is the charge rate used for cycling these cells. As noted above, high charge rates (e.g., at least 0.5 C or, more specifically, at least 1 C) can cause uneven lithium-metal deposits, which may be referred to as “porous” lithium. These uneven deposits provide larger areas (vs. compacted lithium deposits) for SEI formation and cause other undesirable issues. Overall, such deposits can cause an increase in impedance reducing the cycle life.

Described herein are methods and systems for restoring LiMLE cells by cycling such cells using restoring conditions comprising specially selected restoring discharge current (e.g., at least 1 D) and a restoring charge current (e.g., less than 0.5 C). Various triggers can be used for this restoration cycling as further described below. Furthermore, various examples of restoration cycling (also described below) are within the scope. This restoration cycling is specifically designed to mitigate various degradation mechanisms of LiMLE cells, such as SEI formation, porous lithium deposition, and the like. These degradation mechanisms are evident from the triggers used for restoration cycling. Specifically, restoration cycling is triggered when a LiMLE cell reaches a restoring threshold, which corresponds to a certain level of cell degradation. The restoring threshold is determined based on one or more of the following operating and resting conditions of the LiMLE cell, such as a discharge capacity, an overpotential, an impedance, a DCIR, the rest period duration, an open circuit voltage, operating discharge and/or charge currents, and an operating cycle count. This restoring threshold is an electrical signal that is captured in a battery management system (BMS) when a cell is in operation (e.g., in the field, used on a vehicle/charge). For example, when a LiMLE cell within a battery module has had an overall discharge current of less than C/100, the BMS may trigger the restoration cycle method prior to the next charging. Specifically, the restoration cycle method may be a part of the overall state of health (SOH) algorithms. Depending on the duration of rest and SOH of the battery, as an example, the duration of restoration discharge can be 90 seconds in some cases. A full discharge to 0% SOC can be used in other examples as a restoration cycle method.

Without being restricted to any particular theory, it is believed that this restoration cycling at least partially removes the porous lithium layer and/or the SEI layer from the negative electrode or, more specifically, from the LiM surface of the negative electrode. As a result, the DCIR/impedance of LiMLE cells decreases while the power capabilities increase. Furthermore, the overall cycle life of LiMLE cells increases (e.g., maintaining the battery capacity above 80% of the initial capacity). For example, in one experiment, adding the restoration cycling (to the operational cycling of 1 C1 D) increased the cycle life of LiMLE cells by 35%. Furthermore, it has been found that restoration cycling applies to different types of LiMLE cells, i.e., LiMLE cells using different positive active materials and electrolyte compositions. These features are particularly important for aviation and automotive applications of LiMLE cells.

### Examples of LiMLE Cells

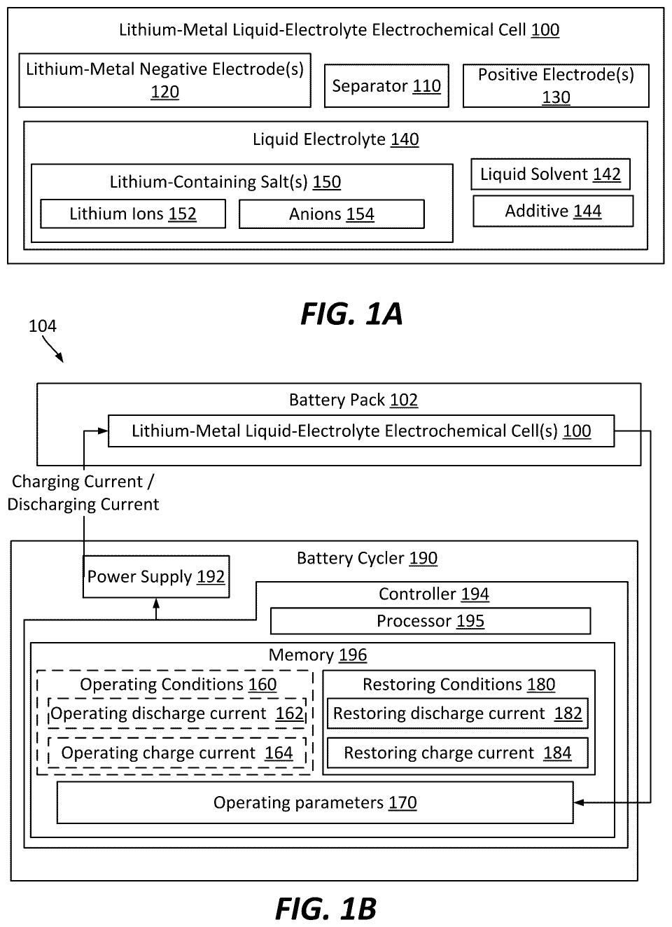

FIG. 1A is a block diagram of LiMLE cell 100, illustrating various components of the cell and providing context to various features further described below, in accordance with some examples. LiMLE cell 100 comprises lithium-metal negative electrode 120, positive electrode 130, and separator 110. Separator 110 is positioned between lithium-metal negative electrode 120 and positive electrode 130 and provides electronic isolation between these electrodes. LiMLE cell 100 also comprises liquid electrolyte 140 which provides ionic transfer between lithium-metal negative electrode 120 and positive electrode 130. For example, liquid electrolyte 140 soaks separator 110 or, more specifically, the pores of separator 110.

Some examples of liquid electrolyte 140 include, but are not limited to, a mixture of lithium-containing salt 150 and liquid solvent 142. Some examples of lithium-containing salt 150 include, but are not limited to, lithium bis(fluorosulfonyl)imide (LiFSI), lithium bis(trifluoromethylsulfonyl)amide (LiTFSI), lithium tetrafluoroborate (LiBF₄), lithium hexafluorophosphate (LiPF₆), lithium bis(oxalato)borate (LiBOB), lithium difluoro(oxalato)borate (LiDFOB), lithium trifluoromethanesulfonate (LiTf), lithium nitrate (LiNO₃), and various combinations thereof. In some examples, lithium-containing salt 150 is LiFSI or LiTFSI, e.g., preferably LiFSI. Lithium-containing salt 150 is configured to dissociate into lithium ions 152 and anions 154. Some examples of liquid solvents 142 but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl)ether (G2), triethylene glycol dimethyl ether (G3), or tetraethylene glycol dimethyl ether (G4), Bis(2,2,2-trifluoroethyl)ether (BTFE); ethylal; 1,1,2,2-tetrafluoroethyl 2,2,3,3-tetrafluoropropyl ether (TFPE)), and combination thereof.

Liquid electrolyte 140 can comprises various additives 144, e.g., metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate)borate (BOB) anions), ionic liquids (e.g., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

In some examples, liquid electrolyte 140 can have a viscosity of at least 15 cP or, more specifically, at least 25 cP, at least 50 cP, or even at least 100 cP at room temperature. High viscosity can be driven by specific components needed in liquid electrolyte 140 to enable the functioning of liquid electrolyte 140 in LiMLE cell 100.

Positive electrode 130 can include a current collector (e.g., an aluminum foil) and an active material layer comprising an active material (e.g., in the form of particles) and a binder (e.g., a polymer binder). Some examples of positive active materials include, but are not limited to, lithium nickel manganese cobalt (NMC) oxides, lithium iron phosphate, and the like. Some examples of suitable binders include, but are not limited to, polymer binders (e.g., polyvinylidene-fluoride (PVDF), styrene butadiene rubber (SBR), and carboxyl methyl cellulose (CMC)). In some examples, positive electrode 130 comprises a conductive additive (e.g., carbon black/paracrystalline carbon).

Lithium-metal negative electrode 120 can also include a current collector on which a lithium metal layer is deposited when LiMLE cell 100 is charged. Some examples of suitable current collectors include, but are not limited to, lithium (remaining after full discharge), copper, nickel, aluminum, stainless steel, a metalized polymer substrate (e.g., metalized with copper), and a carbon-coated metal substrate. The purpose of using a negative electrode with a lithium-metal layer deposited on a current collector (in lithium-metal electrochemical cells) is to reduce the size of the negative electrode (e.g., in comparison to lithium-ion cells). For example, the thickness of the lithium-metal layer can be less than 20 micrometers. Furthermore, the addition of a current collector also helps to keep the thickness of the lithium-metal layer small. For example, thicknesses of less than 20 micrometers are difficult to achieve with freestanding lithium foil. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from the safety perspective as less lithium ejecta (e.g., molten lithium ejecta) needs to be contained when the cell goes into a thermal runaway.

Positive electrode 130, lithium-metal negative electrode 120, separator 110, and liquid electrolyte 140 can be referred to as internal components of LiMLE cell 100. These internal components are sensitive to moisture and other ambient conditions and insulated from the environment by a cell enclosure, such as a metal (e.g., aluminum) case (e.g., for cylindrical or prismatic cells), a pouch laminate, an aluminum-coated polymer (e.g., polyamide, polyester, polyurethane, and polypropylene).

FIG. 1B is a block diagram of battery system 104 comprising LiMLE cell 100 of FIG. 1A. In some examples, LiMLE cell 100 can be a part of battery pack 102, which includes additional LiMLE cells. Multiple LiMLE cells can be used with various types of in-series and/or parallel connections to boost the voltage and/or current of battery pack 102. For purposes of this disclosure, a battery pack and a battery module are used interchangeably. FIG. 1B illustrates various additional components of battery system 104 such as battery cycler 190 used for the restoration cycling of LiMLE cell 100 and, in some examples, for the operation cycling of LiMLE cell 100. For example, battery cycler 190 can be a part of the system that is powered by LiMLE cell 100. In some examples, at least some components of battery cycler 190 (e.g., controller 194) can be a part or integrated into LiMLE cell 100 or, more generally, to battery pack 102. Various trigger methods described in this disclosure can be applied to battery pack of any series and parallel configurations. As an example, a State of Power (SOP) algorithm can automatically detect direct current internal resistance (DCIR) increase of a certain p-group in a battery pack. A 30% increase in DCIR over continuous usage and rest of the battery can trigger a restoration cycle.

In some examples, battery cycler 190 comprises controller 194, which itself comprises processor 195 and memory 196. Memory 196 stores various parameters, e.g., operating conditions 160 (e.g., when battery cycler 190 is used for the operation cycling), restoring conditions 180, and/or operating parameters set 170. In some examples, memory 196 stores operating conditions 160 even when battery cycler 190 is not used for the operation cycling. In these examples, operating conditions 160 can be used by processor 195 to determine restoring conditions 180, e.g., as further described below.

In some examples, battery cycler 190 obtains operating parameters set 170, which can be used for various purposes, e.g., determining a restoring threshold of LiMLE cell 100, determining restoring conditions 180, and other purposes. In some examples, operating conditions 160 are used as a part of operating parameter set 170. However, other examples of operating parameters are within the scope.

Battery cycler 190 can comprise a power supply 192 configured to flow an electric current through LiMLE cell 100 in accordance with restoring conditions 180 or, more specifically, restoring-discharge current 182 and restoring-charge current 184. Specifically, controller 194 can control power supply 192 in accordance with restoring-discharge current 182 and restoring-charge current 184 available in memory 196 of controller 194. In some examples, processor 195 is used to determine restoring-discharge current 182 and restoring-charge current 184. Battery cycler 190 can also be a bi-directional charger that discharges a battery pack upon a restoration cycle and sends energy back to a secondary energy storage system or the electric grid.

When battery cycler 190 is used for the operation cycling of LiMLE cell 100, power supply 192 is also configured to flow an electric current through LiMLE cell 100 in accordance with operating conditions 160 or, more specifically, operating-discharge current 162 and operating-charge current 164. Specifically, controller 194 can control power supply 192 in accordance with operating-discharge current 162 and operating-charge current 164. In some examples, these operating conditions 160 or, more specifically, operating-discharge current 162 is received by controller 194 from the power system (e.g., the power demand).

This restoration cycle can also be applied beyond LiMLE batteries. Any battery cell that experiences slow, parasitic reactions at an electrode-electrolyte interface may experience failure and degradation modes that can be mitigated by restoration cycling. As an example, a high-silicon content (10%+ by weight) anode often decomposes in traditional liquid or next-gen solid electrolyte upon volume expansion and constant exposure to new SEI surfaces in the anode. As another example, Lithium metal batteries with a sulfur cathode also can experience similar failure modes where restoration triggers and subsequent cycling can be applied. As such, methods and systems described herein apply generically to high-performance negative electrodes (anodes) and positive electrodes (cathodes) that tend to form fresh SEI upon cycling and rest, that constantly react with the electrolytes in question.

It should be noted that resurrection cycling described herein may not apply in situations where the electrode-electrolyte interface does not react and enables long lifetimes without a restoration cycle. Some examples of positive electrodes (cathodes) in this category include lithium cobalt oxide (LC), nickel manganese cobalt NMC, lithium iron phosphate (LFP), nickel cobalt aluminum (NCA), when coupled with negative electrodes formed using graphite (with less than 10% by weight silicon content) and traditional carbonate electrolytes with lithium salts.

### Examples of Restoration Cycling of LiMLE Cells

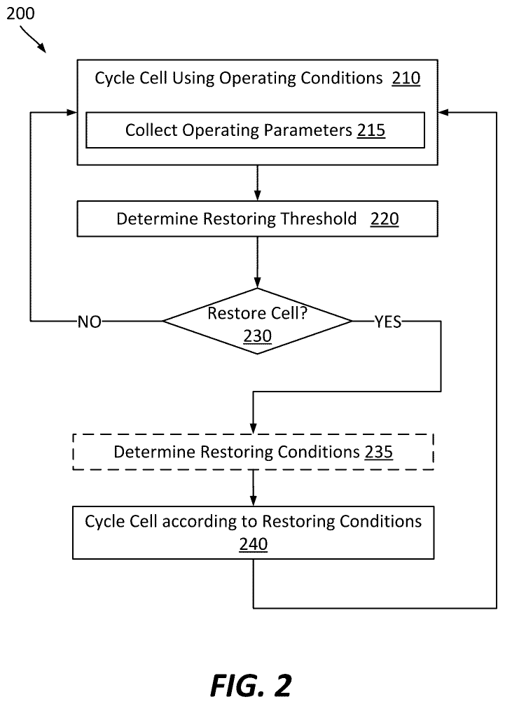

FIG. 2 is a process flowchart corresponding to method 200 of restoring LiMLE cell 100, in accordance with some examples. Various examples of LiMLE cell 100 are described above with reference to FIG. 1A. LiMLE cell 100 can be a part of battery system 104, which further comprises battery cycler 190, used to perform various operations of method 200. Various examples of battery cycler 190 are described above with reference to FIG. 1B.

Method 200 comprises (block 210) cycling a LiMLE cell 100 using operating conditions 160, such as operating-discharge current 162 and operating-charge current 164. In some examples, this cycling operation comprises one or more rest periods. It should be noted that operating conditions 160 can include rest periods, during which operating-discharge current 162 and operating-charge current 164 are at a zero level for a period of time. As further described below, operating conditions 160 can be used to trigger the restoration cycling of separator 110 and, in some examples, to determine/generate restoring conditions 180. Some specific examples of operating conditions 160 will now be described.

For example, LiMLE cell 100 may be stored/shipped at the SOC of between 20% and 40% for a period of at least 2 weeks, at least 4 weeks, at least 8 weeks, or even at least 16 weeks. In some examples, the DCIR of LiMLE cell 100 during such rest periods can increase, e.g., by at least 5%, at least 10%, or even at least 15%. This LiMLE cell 100 may be subjected to a fast discharge (e.g., at 1 D) until the SOC reduces to below 10%, below 5%, or even reaches 0%. However, other examples of the restoration cycling described below are also within the scope. Depending on the rest period at shipping SoC, the restoration cycle can also be for shorter periods, like 90 seconds. The combination of discharge current and discharge time determines the capacity to be discharged that may align with the duration of resting and passivation of the negative electrode/anode surface. This restoration cycling mitigates the DCIR increase (e.g., by effectively dropping the DCIR to the pre-rest level or at least within 5% of the pre-rest level or more specifically within 2% of the pre-rest level). As further described below, this restoration cycling can be triggered by the rest-period duration, the DCIR increase, and/or other factors.

In another example, LiMLE cell 100 is cycled repeatedly using a 1 C1 D protocol, e.g., for at least 20 cycles, at least 40 cycles, or at least 60 cycles. After this cycling, LiMLE cell 100 is rested at 40% SoC for a period of at least 2 weeks, at least 4 weeks, at least 8 weeks, or even at least 16 weeks. For this example, the restoration cycling may include a discharge at least 1.3 D, at least 1.5 D, or even at least 1.7 D, e.g., down to 20% SOC. The discharge rate can be higher than that in the previous example due to the combination of the high cycle count and the rest period.

In yet another example, LiMLE cell 100 is cycled using a 0.3-0.5 D protocol (which may be referred to as slow cycling) for at least 50 cycles or at least 70 cycles. LiMLE cell 100 is then rested on for at least 4 weeks or at least 8 weeks at 60% SOC. For this example, the restoration cycling may include a discharge at 2 D down to 35% SOC.

In some examples, this cycling operation may be performed using a battery cycler 190 (e.g., an onboard charge/battery management system of a vehicle, such as an aircraft). Battery cycler 190 can be also used for restoration cycling. Alternatively, one system may be used to apply operating-discharge current 162 to LiMLE cell 100 and another (different) system may be used to apply operating-charge current 164 to LiMLE cell 100. For example, LiMLE cell 100 (in a charged state) can be installed on an aircraft. Upon discharge, LiMLE cell 100 can be removed from an aircraft and installed on a charger for further charging. Various examples of operating parameters obtained by these systems can be then communicated to battery cycler 190, which is used for restoration cycling.

In some examples, this cycling operation (block 210) comprises (block 215) collecting operating parameters set 170 such as (1) the discharge capacity of LiMLE cell 100 while cycling using operating conditions 160, (2) the overpotential of LiMLE cell 100 while cycling using operating conditions 160, (3) the impedance of LiMLE cell 100; (4) the DCIR of LiMLE cell 100; (5) the rest period duration since cycling; (6) the OCV during the rest period since cycling; (7) operating conditions 160 or, more specifically, operating-discharge current 162 and/or operating-charge current 164 during cycling; and (8) the operating cycle count during cycling using operating conditions 160 after the prior restoration of LiMLE cell 100. Other operating parameter examples are also within the scope. Each of these parameters and the process of collecting these parameters will now be described in more detail.

In one example, a group of LiMLE cells interconnected in series (10 cells in series) show the overpotential increase (at 1 D discharge rate) from by at least 25 mV or even by at least 50 mV (e.g., from a nominal 50 mV to 100 mV) after 12 weeks of storage. Upon this overpotential trigger, a restoration discharge cycle was applied to maintain the overpotential back to nominal values.

In another example, a discharge capacity (at 1 D discharge rate) decreases by at least 5%, by at least 10%, or by at least 20% (e.g., after 80 cycles using a 0.5 C-1 D cycling profile). This loss of capacity may result from cell overpotential (described in the example above) that causes a cell to lose capacity at low states of charge. Thus, restoration cycling can also mitigate capacity loss that is caused by impedance increases.

In yet another example, both cell voltage and capacity dropped by 23% after 6 months of total field usage (resting+operation). This triggered the restoration cycling.

Method 200 comprises (decision block 220) determining a restoring threshold of LiMLE cell 100. Specifically, the restoring threshold is determined based on operating parameters set 170 described above. The process of determining the restoring threshold should be differentiated from the process of determining restoring conditions 180, which can be also performed using operating parameters set 170 and which is described below. First, the process of determining the restoring threshold for each operating parameter and various combinations of these parameters will now be described.

In some examples, the restoring threshold of LiMLE cell 100 can be determined based on the discharge capacity of LiMLE cell 100 while cycling using operating conditions 160. For example, when the discharge capacity of LiMLE cell 100 drops below 85%, below 80%, or even below 75% of the initial discharge capacity (measured at an initial cycle), LiMLE cell 100 has reached its restoring threshold. The discharge capacity value can be obtained using a Coulomb counter during each operational discharge.

In some examples, restoring threshold of LiMLE cell 100 can be determined based on the overpotential of LiMLE cell 100 while cycling using operating conditions 160. For example, the cell's overpotential increase (at the SOC of at least 80% or even at least 90% and a of 1 C-1 D cycling profile) of at least 0.1V, at least 0.2V, or even at least 0.4V can be used as a restoration trigger. The initial cycle can be used as a reference for this overpotential increase.

In some examples, restoring threshold of LiMLE cell 100 can be determined based on the impedance of LiMLE cell 100. For example, an increase in the cell total ohmic+charge transfer impedance by at least 10% or even at least 15% (e.g., to 5 mOhm after 13 weeks) can be used as a restoration trigger.

In some examples, restoring threshold of LiMLE cell 100 can be determined based on the DCIR of LiMLE cell 100. For example, the DCIR increase of at least 10% or at least 20% (e.g., at the SOC of at least 80% or even at least 90%) can be used as a restoration trigger. In one experiment, the DCIR has increased (at the top of charge) by 20% to 6 mOhm after 70 cycles.

In some examples, restoring threshold of LiMLE cell 100 can be determined based on the rest period duration since cycling. For example, the rest period of at least about 8 weeks, at least about 12 weeks, or even at least about 16 weeks can be used as a restoration trigger.

In some examples, restoring threshold of LiMLE cell 100 can be determined based on operating conditions 160 or, more specifically, operating-discharge current 162 and/or operating-charge current 164 during cycling. For example, the condition where operating-discharge current 162 is on average the same or lower than operating-charge current 164 (D≤C) for a set number of cycles (e.g., greater than 5 cycles, greater than 10 cycles) can be used as a restoration trigger. A specific example can be using protocols that have very low discharge currents during either a drive cycle (e.g., low cruise rate for aircraft applications) or running the electronics without performing a drive cycle or fast charging prior to the drive cycle.

In some examples, the restoring threshold of LiMLE cell 100 can be determined based on the operating cycle count during cycling using operating conditions 160 after the prior restoration of LiMLE cell 100, e.g., performing the restoration cycling after at least 5 operation cycles, at least 10 operation cycles, or at least 20 operation cycles. The higher the number of cycles, the more likely the restoration cycle will be effective. This is due to an increased thickness of porous lithium on the surface of the pristine lithium with the increasing number of cycles. The later in the cycle life, the more effective the restoration cycle.

In some examples, method 200 proceeds with (block 235) determining restoring conditions 180, such as restoring-discharge current 182 and restoring-charge current 184 as well as other conditions, e.g., the number of restoration cycles, cutoff voltages, rest periods, temperatures, and the like. Restoring conditions 180 can be determined based on various operating parameters and/or from the restoring threshold (e.g., which ones of multiple restoring thresholds have been reached).

In some examples, when LiMLE cell 100 reaches the restoring threshold (decision block 230), method 200 proceeds with (block 240) cycling a LiMLE cell 100 using restoring conditions 180, which comprises restoring-discharge current 182 and restoring-charge current 184 thereby restoring LiMLE cell 100. Various examples of restoring conditions 180 will now be described in more detail.

In some examples, restoring-discharge current 182 is at least 1 D on average or, more specifically, at least 2D or even at least 3D. For purposes of this disclosure, 1 D is defined as a current level that discharges a cell from 100% to 0% SOC in 1 hour. Without being restricted to any particular theory, it is believed that such large values of restoring-discharge current 182 help to at least partially remove the SI layer from the surface of lithium-metal negative electrode 120 during the discharge portion of the restoration cycling (block 240). As noted above, a higher discharge current (than used during operational cycles) strips off the “dead lithium” from the surface of the negative electrode that forms as roots/tips rather than “flat surface” Lithium. The fast discharge removes additional lithium formed from the previous charge that causes uneven/dendritic lithium plating. When charging LiMLE cell 100, the electrodeposition occurs where Li+ ions are reduced to form lithium metal. Due to the reactive nature of Li metal, the ions do not plate uniformly, leading to a porous dendritic structure. Applying high discharge currents leads to preferential stripping of the porous lithium “tips”, resulting in a denser lithium layer. The surface area of lithium is therefore reduced with a less dendritic structure, prolonging cycle life. By applying restoration cycles we see a reduction in thickness growth, which indicates densely plated lithium.

In some examples, restoring-discharge current 182 is at least 2 times greater than restoring-charge current 184 or, more specifically, at least 4 times greater, or even at least 8 times greater. As noted above, a higher discharge depth helps with removing additional capacity that is formed by dendritic lithium deposition and slow reaction between the liquid electrolyte and lithium anode surface. This additional “parasitic discharge capacity” can facilitate degradation if a cell is cycled afterward. Without being restricted to any particular theory, it is believed that the higher the discharge rate and the lower the charge rate the more densely the lithium is packed due to the mechanism described above.

In some examples, the restoration cycling (block 240) comprises discharging LiMLE cell 100 using restoring-discharge current 182 by at least 10% of the total discharge capacity of LiMLE cell 100. One having ordinary skill in the art would appreciate that the discharge level corresponds to the amount of lithium metal removed from lithium-metal negative electrode 120. The higher discharge value corresponds to more lithium metal removed and transferred to positive electrode 130. Without being restricted to any particular theory, it is believed that the removal of lithium metal can at least partially remove the SEI layer supported on this lithium metal. Removing more lithium metal increases the potential amount of SEI layer being removed. Higher discharge depth helps in removing additional capacity that is formed by dendritic lithium deposition and slow reaction between the liquid electrolyte and lithium anode surface.

In some examples, the restoration cycling (block 240) comprises discharging LiMLE cell 100 until the restoring-discharge cutoff voltage is less than 3.7V or even less than 3.5V. One having ordinary skill in the art would appreciate that the discharge cutoff voltage represents the residual amount of lithium metal on lithium-metal negative electrode 120. Without being restricted to any particular theory, it is believed that leaving less residual lithium metal on lithium-metal negative electrode 120 increases the potential amount of SEI layer being removed (as less lithium metal is available to support the SEI layer).

In some examples, the charge cut-off voltage during the restoration cycling is at least 4.2V or, more specifically, at least 4.25V, or even at least 4.28V.

In some examples, the restoration cycle (block 240) is performed multiple times. The number of these restoration cycles can be a part of restoring conditions 180 (e.g., in addition to restoring-discharge current 182 and restoring-charge current 184). The number of these restoration cycles can be determined from operating parameter set 170 (e.g., prior to initiating the restoration cycling). In the same or other examples, the number of these restoration cycles is reviewed after each restoration cycle, e.g., LiMLE cell 100 is tested for one or more operating parameters to determine if one or more additional restoration cycles are needed. Because of their repeating nature, these restoration cycles can be also referred to as alternating current (AC) resurrection. It should be noted that AC resurrection uses direct current (DC) during each charge and discharge portion of each resurrection cycle.

In some examples, LiMLE cell 100 is part of a battery pack such that the battery pack is cycled in accordance with restoring conditions. In these examples, the restoring threshold is determined based on one or more characteristics of additional LiMLE cells in the battery pack.

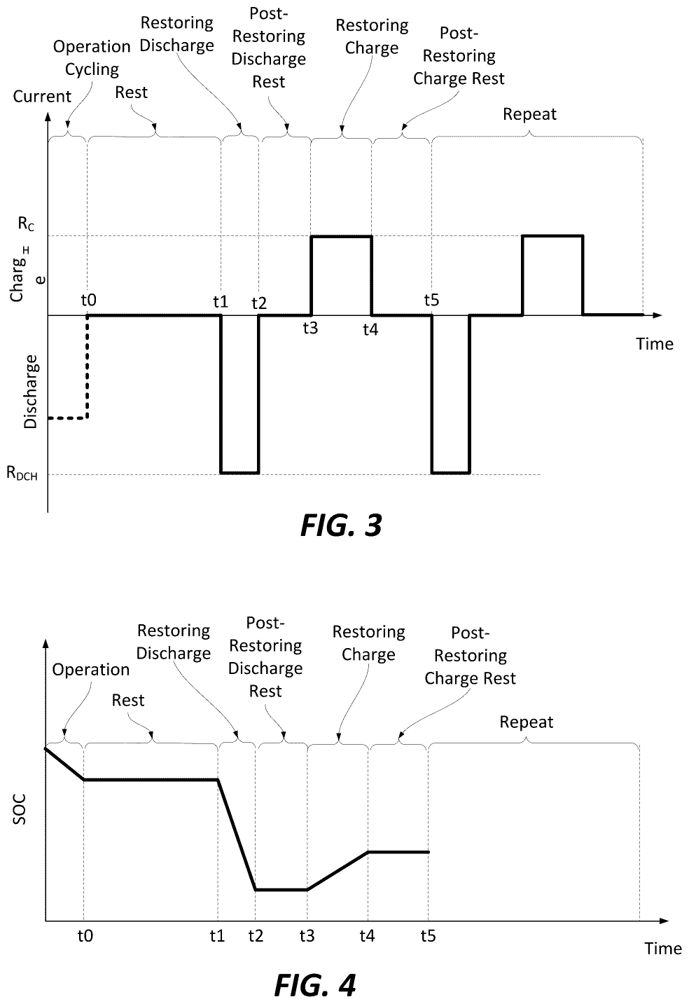

FIG. 3 is a plot of charge/discharge rates used for restoring LiMLE cell 100, in accordance with some examples. For example, the operation cycling of LiMLE cell 100 may end at t₀, at which point LiMLE cell 100 is rested until t₁. This rest period is optional, and, in some examples, LiMLE cell 100 proceeds directly into restoration cycling. In some examples, the rest period (e.g., in combination with other parameters) may be used to trigger restoration cycling. The rest period may be considered a part of the overall cell operation and reflected in operating conditions 160. At t₁, LiMLE cell 100 can be subjected to restoring discharge, which continues until t₂. In this example, the restoration cycling starts with a restoration discharge. In some examples (e.g., low SOC levels), the restoration cycling starts with a restoration charge. LiMLE cell 100 is then rested until t₃, at this point, LiMLE cell 100 is subjected to the restoring charge. However, this rest period is optional. The restoring charge proceeds until t₄, at which point LiMLE cell 100 is rested until t₅. The example in FIG. 3 illustrates that the restoration cycling is optionally repeated after this rest period. FIG. 4 is a schematic illustration of a state of charge (SOC) profile while restoring LiMLE cell 100, in accordance with the example shown in FIG. 3.

### Experimental Data

Various experiments have been conducted to determine the effects of various methods described above on the performance of LiMLE cells. In one experiment, the DCIR measurement was performed on a set of cells LiMLE cells before and after performing the restoration discharge (at the 1 D discharge rate down to the 3V discharge voltage). The DCIR measurement was measured at three different temperatures and three different SOC levels. The results are presented in the table below and indicate a DCIR drop of about 20% on average across different temperatures and SOC levels.

DCIR [mOhm]

| | SOC | | | | | | | | |
|---|---|---|---|---|---|---|---|---|---|
| | 10% SoC | | | 50% SoC | | | 100% SoC | | |
| | Restoration | | | | | | | | |
| Temp | No | Yes | Delta | No | Yes | Delta | No | Yes | Delta |
| 25° C. | 14.5 | 12.5 | 13.8% | 10.5 | 8.5 | 19.0% | 11 | 9 | 18.2% |
| 35° C. | 11.3 | 9 | 20.4% | 9.3 | 7.3 | 21.5% | 10 | 7.7 | 23.0% |
| 45° C. | 9.8 | 7.7 | 21.4% | 8.5 | 6.4 | 24.7% | 9 | 7.1 | 21.1% |

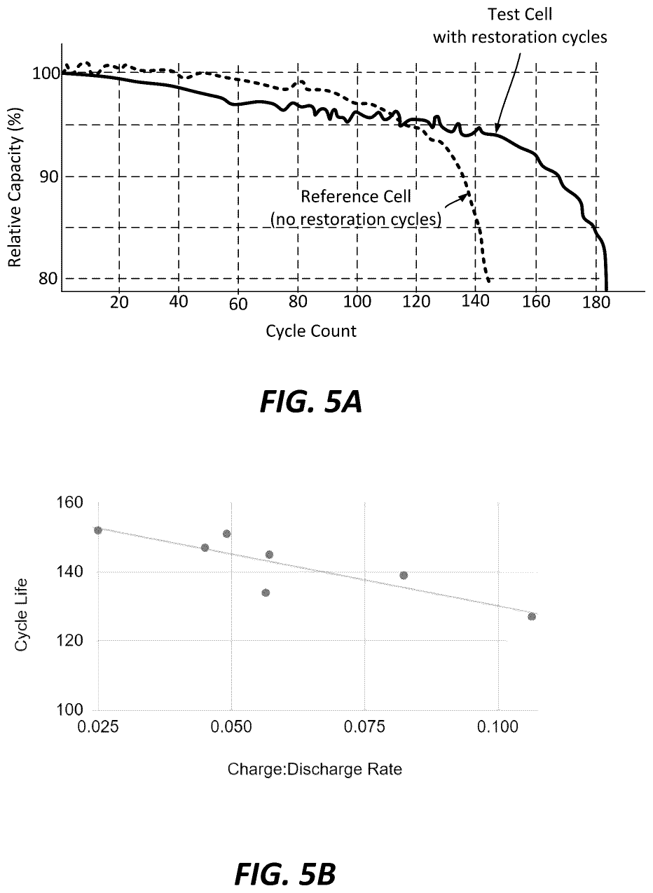

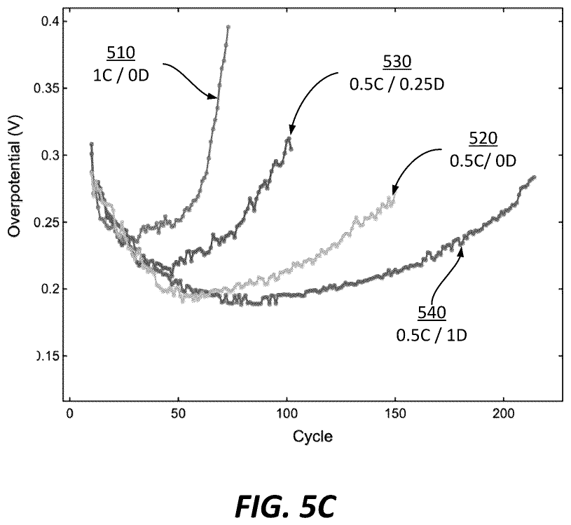

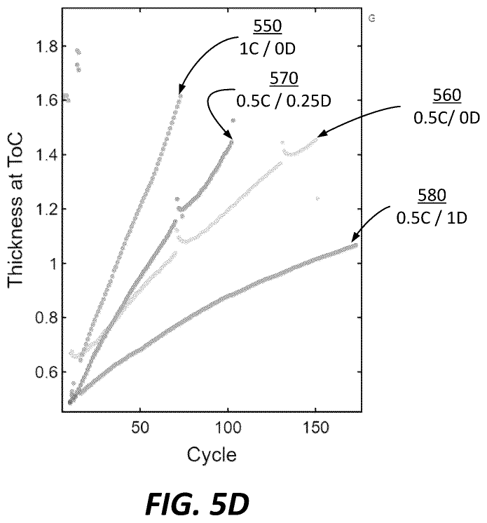

FIG. 5A illustrates the results of another experiment or, more specifically, the relative capacity plots for two LiMLE cells (i.e., the reference cell and the test cell). Both cells were cycled using the 1 C-1 D protocol. The reference cell was not subjected to any restoration cycling. The test cell was subjected to a restoration cycle using a C/8 charge rate and a 5 D discharge rate (i.e., 0.125 C-5 D) every 7 cycles within the 1 C-1 D cycling protocol. The relative capacity is defined as a discharge capacity at a current cycle relative to the initial cycle. The cycle life is defined as the number of cycles with a relative capacity of no less than 80%. The results indicate that incorporating this 0.125 C-5 D restoration cycle extends the cycle life by about 40 cycles/30%.

In another experiment, restoration cycles with different ratios of charge and discharge rates (i.e., C-D rates were tested) were used to determine the cycle life (i.e., the number of cycles with a relative capacity of no less than 80%). 7 different cells were tested across the C-D rates between 0.025 and 0.125 with the results presented in FIG. 5B. It has been found that lower C-D rates provide the longest cycle life in LiMLE cells. Specifically, lowering the C-D rate from 0.125 to 0.025 increases the cycle life from about 125 cycles to about 155 cycles.

In yet another experiment, the overpotential of four LiMLE cells was monitored over multiple cycles that were subjected to different charge and discharge rates before measuring the overpotential. The results are presented in FIG. 5C. Specifically, line 510 corresponds to a cell that has been subjected to a 1 C charge rate and no subsequent discharge before measuring the overpotential. Line 520 corresponds to a cell that has been subjected to a 0.5 C charge rate and no subsequent discharge before measuring the overpotential. This cell may be viewed as a reference cell. Line 530 corresponds to a cell that has been subjected to a 0.5 C charge rate and 0.25 D discharge before measuring the overpotential. Finally, line 540 corresponds to a cell that has been subjected to a 0.5 C charge rate and 1 D discharge before measuring the overpotential. This last cell showed the lowest overpotential increase over the cycle life. It should be noted that the 0.25 D discharge is not sufficient to mitigate the overpotential increase, which supports the earliest finding that low C-D rates (e.g., lower than 0.125) provide restoration effects. The primary source of the resistance is from the SEI/porous lithium build-up so applying the discharge pulse directly after the landing “restores” the lithium by removing the SEI/porous lithium. This conclusion is also supported by the thickness data for these four LiMLE cells presented in FIG. 5D. Specifically, line 550 corresponds to a cell that has been subjected to a 1 C charge rate and no subsequent discharge before measuring the overpotential. Line 560 corresponds to a cell that has been subjected to a 0.5 C charge rate and no subsequent discharge before measuring the overpotential. This cell may be viewed as a reference cell. Line 570 corresponds to a cell that has been subjected to a 0.5 C charge rate and 0.25 D discharge before measuring the overpotential. Finally, line 580 corresponds to a cell that has been subjected to a 0.5 C charge rate and 1 D discharge before measuring the overpotential.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method for restoring a lithium-metal liquid-electrolyte electrochemical cell comprising a lithium-metal negative electrode and a liquid electrolyte comprising a lithium-containing salt and a liquid solvent, the method comprising:
cycling the lithium-metal liquid-electrolyte electrochemical cell using operating conditions comprising an operating discharge current and an operating charge current;
determining a restoring threshold of the lithium-metal liquid-electrolyte electrochemical cell; and
when the lithium-metal liquid-electrolyte electrochemical cell reaches the restoring threshold, cycling the lithium-metal liquid-electrolyte electrochemical cell using restoring conditions comprising a restoring discharge current and a restoring charge current thereby restoring the lithium-metal liquid-electrolyte electrochemical cell, wherein the restoring discharge current is at least 1 D on average.

2. The method of claim 1, wherein the restoring threshold is determined based on one or more of:
a discharge capacity of the lithium-metal liquid-electrolyte electrochemical cell while cycling using the operating conditions,
an overpotential of the lithium-metal liquid-electrolyte electrochemical cell while cycling using the operating conditions,
an impedance of the lithium-metal liquid-electrolyte electrochemical cell,
a direct-current (DC) resistance of the lithium-metal liquid-electrolyte electrochemical cell,
duration of a rest period since cycling the operating conditions,
an open circuit voltage (OCV) during the rest period since cycling using the operating conditions,
the operating discharge current and the operating charge current during cycling using the operating conditions, and
an operating cycle count using the operating conditions after a prior restoration of the lithium-metal liquid-electrolyte electrochemical cell.

3. The method of claim 2, wherein:
the restoring threshold is determined based on the discharge capacity of the lithium-metal liquid-electrolyte electrochemical cell while cycling using the operating conditions, and
the lithium-metal liquid-electrolyte electrochemical cell reaches the restoring threshold when the discharge capacity is 5-30% relative to an initial capacity.

4. The method of claim 2, wherein:
the restoring threshold is determined based on the overpotential of the lithium-metal liquid-electrolyte electrochemical cell while cycling using the operating conditions, and
the lithium-metal liquid-electrolyte electrochemical cell reaches the restoring threshold when the overpotential increases by 0.1-1.0V over an initial overpotential.

5. The method of claim 2, wherein:
the restoring threshold is determined based on the impedance of the lithium-metal liquid-electrolyte electrochemical cell, and
the lithium-metal liquid-electrolyte electrochemical cell reaches the restoring threshold when the impedance increases by 10-50% relative to an initial impedance.

6. The method of claim 2, wherein:
the restoring threshold is determined based on the direct-current (DC) resistance of the lithium-metal liquid-electrolyte electrochemical cell, and
the lithium-metal liquid-electrolyte electrochemical cell reaches the restoring threshold when the direct-current (DC) resistance increases by 10-50% relative to an initial direct-current (DC) resistance.

7. The method of claim 2, wherein:
the restoring threshold is determined based on the duration of the rest period since cycling the operating conditions, and
the lithium-metal liquid-electrolyte electrochemical cell reaches the restoring threshold when the duration of the rest period is 8 weeks to 1 year.

8. The method of claim 2, wherein:
the restoring threshold is determined based on the open circuit voltage (OCV) during the rest period since cycling using the operating conditions, and
the lithium-metal liquid-electrolyte electrochemical cell reaches the restoring threshold when the open circuit voltage (OCV) drops by at least about 0.05V.

9. The method of claim 1, wherein cycling the lithium-metal liquid-electrolyte electrochemical cell using the restoring conditions comprises discharging the lithium-metal liquid-electrolyte electrochemical cell using the restoring discharge current by 5-50% of a discharge capacity of the lithium-metal liquid-electrolyte electrochemical cell.

10. The method of claim 1, wherein the restoring conditions further comprise a restoring discharge cutoff voltage of less than 3.7V such that the lithium-metal liquid-electrolyte electrochemical cell is discharged using the restoring discharge current until the restoring discharge cutoff voltage.

11. The method of claim 1, wherein the restoring discharge current is at least 0.75 D.

12. The method of claim 1, wherein the restoring discharge current is at least 2 times greater than the restoring charge current.

13. The method of claim 1, wherein the lithium-metal liquid-electrolyte electrochemical cell is part of a battery pack such that the battery pack is cycled in accordance with the restoring conditions.

14. The method of claim 13, wherein the restoring threshold is determined based on one or more characteristics of additional lithium-metal liquid-electrolyte electrochemical cells in the battery pack.

15. A battery system for restoring a lithium-metal liquid-electrolyte electrochemical cell, the battery system comprising:
a power supply configured to flow an electric current through the lithium-metal liquid-electrolyte electrochemical cell in accordance with a set of restoring conditions comprising a restoring charge current and a restoring discharge current; and
a controller, communicatively coupled to the power supply and comprising:
a memory storing the restoring conditions and operating parameters of the lithium-metal liquid-electrolyte electrochemical cell, and
a processor configured to determine a restoring threshold of the lithium-metal liquid-electrolyte electrochemical cell such that when the lithium-metal liquid-electrolyte electrochemical cell reaches the restoring threshold, the processor is configured to instruct the power supply to cycle the lithium-metal liquid-electrolyte electrochemical cell using restoring conditions comprising a restoring discharge current and a restoring charge current thereby restoring the lithium-metal liquid-electrolyte electrochemical cell,
wherein the restoring discharge current is at least 1 D on average.

16. The battery system of claim 15, wherein the restoring threshold is determined based on one or more of:
a discharge capacity of the lithium-metal liquid-electrolyte electrochemical cell while cycling using the operating conditions,
an overpotential of the lithium-metal liquid-electrolyte electrochemical cell while cycling using the operating conditions,
an impedance of the lithium-metal liquid-electrolyte electrochemical cell,
a direct-current (DC) resistance of the lithium-metal liquid-electrolyte electrochemical cell,
duration of a rest period since cycling the operating conditions,
an open circuit voltage (OCV) during the rest period since cycling using the operating conditions,
the operating discharge current and the operating charge current during cycling using the operating conditions, and
an operating cycle count using the operating conditions after a prior restoration of the lithium-metal liquid-electrolyte electrochemical cell.

17. The battery system of claim 16, wherein:
the restoring threshold is determined based on the discharge capacity of the lithium-metal liquid-electrolyte electrochemical cell while cycling using the operating conditions, and
the lithium-metal liquid-electrolyte electrochemical cell reaches the restoring threshold when the discharge capacity is 5-30% relative to an initial capacity.

18. The battery system of claim 16, wherein:
the restoring threshold is determined based on the overpotential of the lithium-metal liquid-electrolyte electrochemical cell while cycling using the operating conditions, and
the lithium-metal liquid-electrolyte electrochemical cell reaches the restoring threshold when the overpotential increases by 0.1-1.0V over an initial overpotential.

19. The battery system of claim 16, wherein:
the restoring threshold is determined based on the impedance of the lithium-metal liquid-electrolyte electrochemical cell, and
the lithium-metal liquid-electrolyte electrochemical cell reaches the restoring threshold when the impedance increases by 10-50% relative to an initial impedance.

20. The battery system of claim 16, wherein:
the restoring threshold is determined based on the direct-current (DC) resistance of the lithium-metal liquid-electrolyte electrochemical cell, and
the lithium-metal liquid-electrolyte electrochemical cell reaches the restoring threshold when the direct-current (DC) resistance increases by 10-50% relative to an initial direct-current (DC) resistance.
